(19) United States
(12) Patent Application Publication
(10) Pub. No.: US 2026/0127127 A1
(43) Pub. Date: May 7, 2026

(54) ELECTRONIC DEVICE INCLUDING SENSOR SWITCH, AND DROP MISRECOGNITION PREVENTION METHOD THEREFOR

(71) Applicant: Samsung Electronics Co., Ltd., Suwon-si (KR)

(72) Inventors: Sejin PARK, Suwon-si (KR); Wanju BYUN, Suwon-si (KR); Sean KWON, Suwon-si (KR); Donginn SEO, Suwon-si (KR); Changin SONG, Suwon-si (KR); Dohyeon LEE, Suwon-si (KR); Dongmin LEE, Suwon-si (KR); Hyunju HONG, Suwon-si (KR)

(21) Appl. No.: 19/434,862

(22) Filed: Dec. 29, 2025

Related U.S. Application Data
(63) Continuation of application No. PCT/KR2024/008894, filed on Jun. 26, 2024.

(30) Foreign Application Priority Data
Jul. 3, 2023 (KR) 10-2023-0085869
Aug. 31, 2023 (KR) 10-2023-0115514

(51) Int. Cl. G06F 13/40; G01P 15/18; G06F 1/16

(52) U.S. Cl. CPC G06F 13/4022; G01P 15/18; G06F 1/1652

(57) ABSTRACT

An electronic device is provided. The electronic device includes a housing, an antenna, a display, a driving unit that moves at least a portion of the display, a first sensor that identifies a first measurement value for detecting motion information of the electronic device, a second sensor that identifies a second measurement value for detecting grip information of the electronic device, a first circuit and a second circuit that are selectively connectable to the second sensor, a switch by which one of the first circuit and the second circuit is electrically connected to the antenna, memory, comprising one or more storage media, storing instructions, and at least one processor communicatively coupled to the switch, the first sensor, the second sensor, and the memory, wherein the instructions, when executed by the at least one processor individually or collectively, cause the electronic device to control the switch so that one of the first circuit and the second circuit is electrically connected to the antenna based on the identified first measurement value and the identified second measurement value in a first state in which at least a portion of the display is withdrawn from the housing using the driving unit.

### CROSS-REFERENCE TO RELATED APPLICATION(S)

This application is a continuation application, claiming priority under 35 U.S.C. § 365(c), of an International application No. PCT/KR2024/008894, filed on Jun. 26, 2024, which is based on and claims the benefit of a Korean patent application number 10-2023-0085869, filed on Jul. 3, 2023, in the Korean Intellectual Property Office, and of a Korean patent application number 10-2023-0115514, filed on Aug. 31, 2023, in the Korean Intellectual Property Office, the disclosure of each of which is incorporated by reference herein in its entirety.

### BACKGROUND

### 1. Field

The disclosure relates to an electronic device including a sensor switch and a drop misrecognition prevention method therefor.

### 2. Description of Related Art

Electronic devices are evolving into various structures to meet the needs of users who want various functions.

Recently, electronic devices that support the functions of electronic devices through sliding or rolling mechanisms (e.g., slidable electronic devices, rollable electronic devices) have been released. These electronic devices may include a driving structure (e.g., a slide body) designed such that some components of the electronic device are drawn out by the rotational force of a driving unit (e.g., a driving motor), or are seated back by reversing the rotation of the driving unit.

However, when electronic devices are subjected to an external impact, such as a drop, while some components of the electronic device are drawn out, the components operatively connected to the driving structure (e.g., flexible display, driving motor, camera lens, electronic components) may be damaged.

Moreover, electronic devices may be more vulnerable to damage from external impacts, such as a drop, when some components of the electronic device are drawn out compared to when they are retracted. Electronic devices may require measures to minimize impact by reversing the driving motor to protect the components during a drop state.

The above information is presented as background information only to assist with an understanding of the disclosure. No determination has been made, and no assertion is made, as to whether any of the above might be applicable as prior art with regard to the disclosure.

### SUMMARY

When an electronic device detects a drop state while some components of the electronic device are drawn out, the electronic device may support a drop detection misrecognition solution function or a drop misrecognition prevention function that determines whether the drop state recognition is a malfunction on the basis of the grip status, and accordingly, either reverses the rotation of the motor or maintains the current state.

Meanwhile, the grip sensor used for recognizing the grip status must meet the object recognition distance according to the specific absorption rate (SAR) measurement standard, and so the sensing path may be tuned with defined sensing features. However, since the object recognition distance for the drop misrecognition solution is different from the SAR measurement standard, there is a limitation in utilizing a single grip sensor for both SAR measurement purpose and the drop misrecognition solution purpose.

Consequently, the electronic device may require a separate sensing path for the grip sensor, in addition to the sensing path of the grip sensor for SAR measurements, for use in drop detection misrecognition solution (or for drop detection monitoring). However, adding a separate grip sensor to the electronic device may result in hardware constraints not only because of the additional allocation of connection wiring for linking with the control processor but also because of mounting location and increased connection wiring.

Aspects of the disclosure are to address at least the above-mentioned problems and/or disadvantages and to provide at least the advantages described below. Accordingly, an aspect of the disclosure is to provide an electronic device which proposes a structure and method that can utilize a single grip sensor not only for grip state determination (or SAR measurement) but also for a drop detection misrecognition solution (or drop detection monitoring) by using a sensor switch without adding a separate grip sensor.

Additional aspects will be set forth in part in the description which follows and, in part, will be apparent from the description, or may be learned by practice of the presented embodiments.

In accordance with an aspect of the disclosure, an electronic device is provided. The electronic device includes a housing, an antenna, a display, a driving unit that moves at least a portion of the display, a first sensor that identifies a first measurement value for detecting motion information of the electronic device, a second sensor that identifies a second measurement value for detecting grip information of the electronic device, a first circuit and a second circuit that are selectively connectable to the second sensor, a switch by which one of the first circuit and the second circuit electrically connected to the antenna, memory, comprising one or more storage media, storing instructions, and at least one processor communicatively coupled to the switch, the first sensor, the second sensor, and the memory, wherein the instructions, when executed by the at least one processor individually or collectively, cause the electronic device to control the switch so that one of the first circuit and the second circuit is electrically connected to the antenna based on the identified first measurement value and the identified second measurement value in a first state in which at least a portion of the display is withdrawn from the housing using the driving unit.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include controlling a switch so that one of a first circuit and a second circuit is electrically connected to an antenna based on an identified first measurement value and an identified second measurement value in a first state in which at least a portion of a display is withdrawn from a housing using a driving unit.

The electronic device includes an antenna, a display, a driving unit that moves at least a portion of the display, a first sensor that identifies a first measurement value for detecting motion information of the electronic device, a second sensor that identifies a second measurement value for detecting grip information of the electronic device, a first circuit and a second circuit that are selectively connectable to the antenna and the second sensor, a switch by which one of the first circuit and the second circuit is electrically connected to the antenna, and a low-power processor operatively connected to the switch, the first sensor, and the second sensor. The low-power processor is configured to control a switch for selectively connecting one of the first circuit and the second circuit to the antenna and the second sensor on the basis of the first measurement value and the second measurement value in a first state in which at least a portion of the display is withdrawn from the electronic device. The low-power processor is configured to control the switch for connecting the first circuit and the second sensor in a second state in which at least a portion of the display is retracted into the interior of the electronic device.

An electronic device supports a function of changing to a first state in which a portion of the electronic device is moved by a rotational force or a second state in which a portion of the electronic device is seated back by a reverse rotation, and includes a sensor switch structure that selectively connects a first electrical path for SAR measurement and a second electrical path for a drop detection misrecognition solution to one grip sensor in an electronic device including a sensor for detecting a free drop (or a drop state).

A drop misrecognition prevention method of an electronic device including a display in which at least a portion of the display is withdrawn from the electronic device or is retracted into the interior of the electronic device according to various embodiments includes obtaining a first measurement value identified from a first sensor for detecting electronic device motion information, obtaining a second measurement value identified from a second sensor for detecting electronic device grip information, and controlling a switch that selectively connects one of a first circuit and a second circuit to the antenna and the second sensor on the basis of the first measurement value and the second measurement value in a first state in which at least a portion of the display is withdrawn from the electronic device.

A recording medium storing a program for executing on a computer a drop misrecognition prevention method of an electronic device including a display in which at least a portion of the display is withdrawn from the electronic device or is retracted into the interior of the electronic device according to various embodiments includes a configuration for obtaining a first measurement value identified from a first sensor for detecting electronic device motion information, obtaining a second measurement value identified from a second sensor for detecting electronic device grip information, and controlling a switch that selectively connects one of a first circuit and a second circuit to the antenna and the second sensor on the basis of the first measurement value and the second measurement value in a first state in which at least a portion of the display is withdrawn from the electronic device.

Electronic devices, methods and recording media improve prevention of damage to electronic devices because of external impacts such as a drop by reducing latency until reverse rotation control of a driving unit by having a low-power processor control sensors and sensor switches and transmitting a driving interrupt signal to a main processor through a wire connected to a driving driver.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device 101 in a network environment 100 according to an embodiment of the disclosure;

FIGS. 2A and 2B are diagrams illustrating the front surface and the rear surface of an electronic device in a slide-in state according to various embodiments of the disclosure;

FIGS. 3A and 3B are diagrams illustrating the front surface and the rear surface of an electronic device in a slide-out state according to various embodiments of the disclosure;

FIG. 4 is an exploded perspective view of an electronic device according to an embodiment of the disclosure;

FIG. 5A illustrates a block diagram of an electronic device including a sensor switch according to an embodiment of the disclosure;

FIG. 5B illustrates a layout diagram of some components of the electronic device illustrated in FIG. 5A according to an embodiment of the disclosure;

FIG. 6 illustrates a block diagram of an electronic device including a sensor switch according to an embodiment of the disclosure;

FIGS. 7A and 7B illustrate a drop detection misrecognition method of an electronic device including a sensor switch according to various embodiments of the disclosure;

FIG. 8 illustrates the mode operation timing of a sensor switch according to an embodiment of the disclosure; and

FIG. 9 illustrates a drop detection misrecognition method of an electronic device including a sensor switch according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Electronic devices according to the embodiments disclosed in this document may take various forms. Electronic devices may include, for example, portable communication devices (e.g., smartphones), computer devices, portable multimedia devices, portable medical devices, cameras, wearable devices, or home appliances. Electronic devices according to the embodiments disclosed in this document are not limited to the aforementioned devices.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

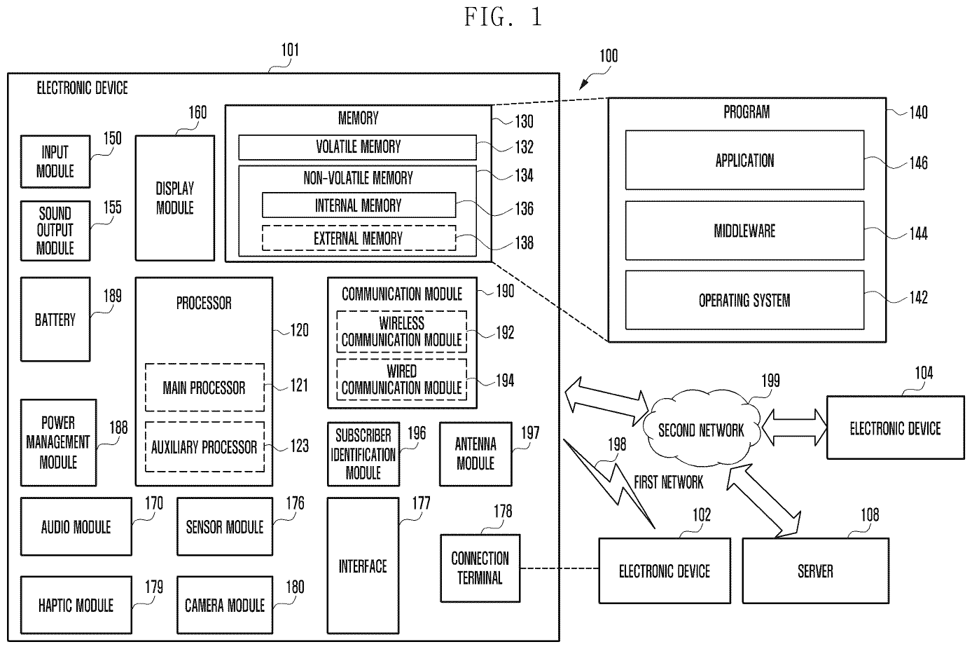

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to another embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to another embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may be configured to output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to another embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to another embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to another embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth®, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to another embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to another embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be, for example, an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

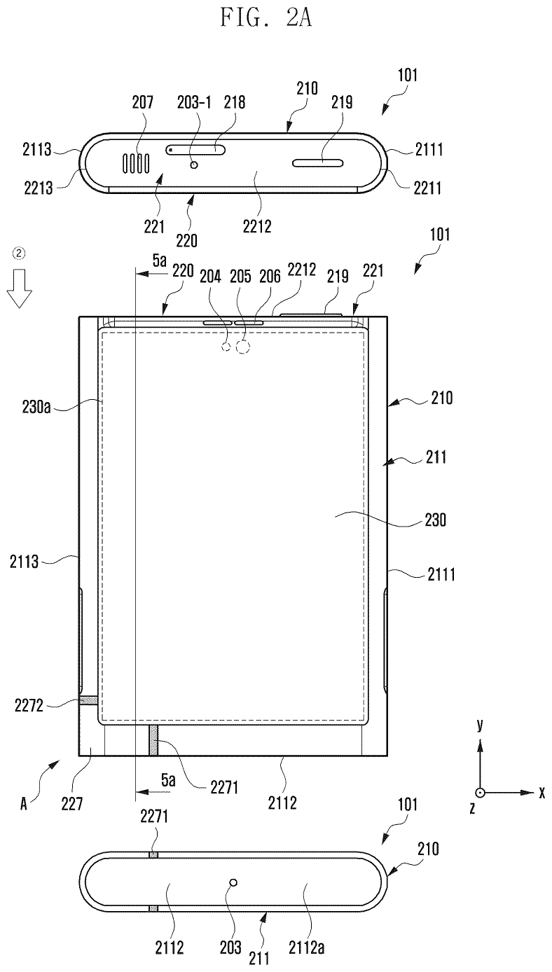

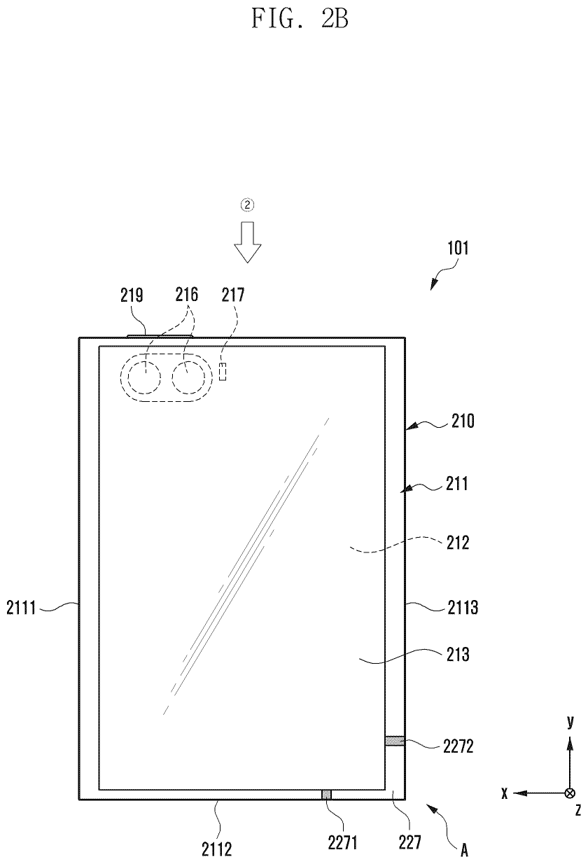

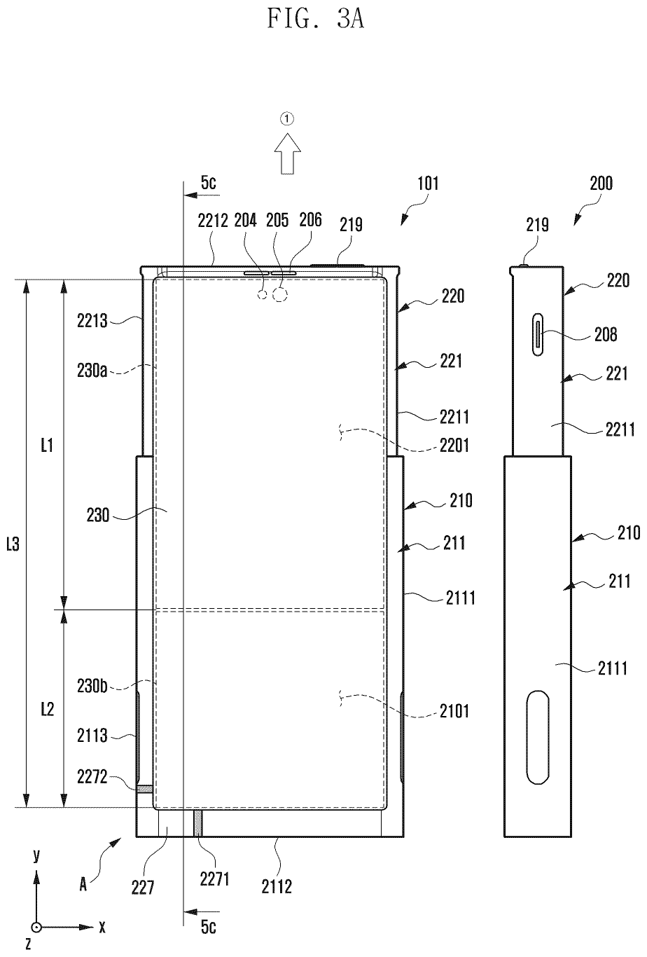

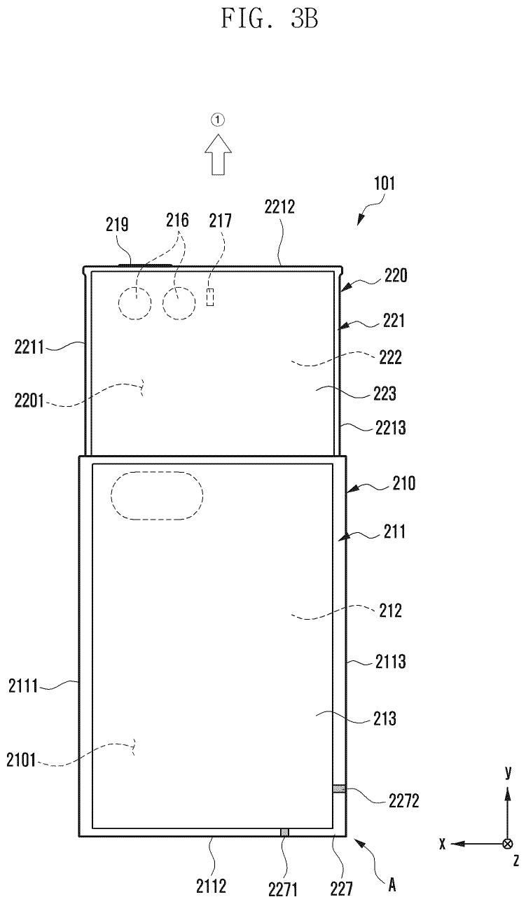

FIGS. 2A and 2B are diagrams illustrating the front surface and the rear surface of an electronic device in a slide-in state according to various embodiments of the disclosure. FIGS. 3A and 3B are diagrams illustrating the front surface and the rear surface of an electronic device in a slide-out state according to various embodiments of the disclosure.

The electronic device 101 of FIGS. 2A, 2B, 3A, and 3B may be at least partially similar to the electronic device 101 of FIG. 1 or may further include other embodiments of the electronic device.

Referring to FIGS. 2A, 2B, 3A, and 3B, the electronic device 101 may include a first housing 210, a second housing 220 that is slidably coupled from the first housing 210 in a specified direction (e.g., direction \textcircled{1} or direction \textcircled{2}) (e.g., ±y-axis direction), and a display 230 (e.g., a rollable display, a flexible display, an expandable display, or a stretchable display) that is disposed to be supported by at least a portion of the first housing 210 and the second housing 220. In one embodiment, the second housing 220 may be slidably coupled to the first housing 210 so as to be slid out in a first direction (direction \textcircled{1}) or slid in in a second direction (direction \textcircled{2}) opposite to the first direction (direction \textcircled{1}) with respect to the first housing 210. Conversely, the first housing 210 may be slidably coupled to the second housing 220 so as to be slid out in a first direction (direction \textcircled{1}) with respect to the second housing 210 or slid in in a second direction (direction \textcircled{2}) opposite to the first direction (direction \textcircled{1}).

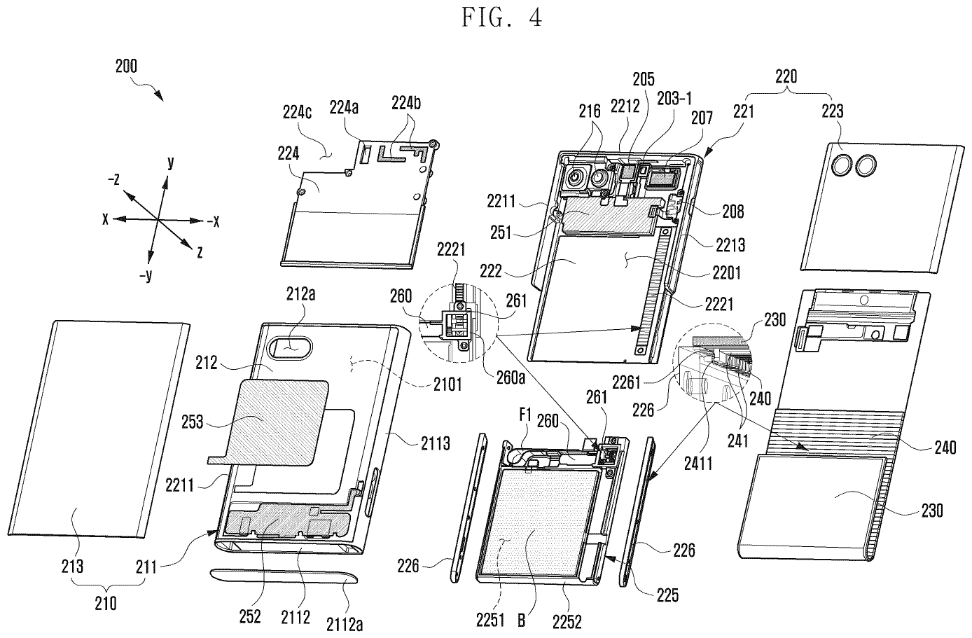

In an embodiment, the electronic device 101 may be changed into a slide-in state (e.g., a retracted state) by accommodating at least a portion of the second housing 220 into at least a portion of the first space 2101 formed by the first housing 210. In one embodiment, the electronic device 101 may be changed into a slide-out state (e.g., a drawn out state) by moving at least a portion of the second housing 220 outwardly (e.g., in direction \textcircled{1}) from the first space 2101. In one embodiment, the electronic device 101 may include a support member (e.g., the support member 240 of FIG. 4) (e.g., a bendable member, a bendable support member, a multi-joint hinge module or multibar assembly) that, in a slide-out state, forms at least partially the same plane as at least a portion of the second housing 220, and, in a slide-in state, is accommodated in a bending manner into the first space 2101 of the first housing 210. In one embodiment, at least a portion of the display 230 may be disposed in such a manner that it is attached to at least a portion of the second housing 220. In one embodiment, at least a portion of the remaining portion of the display 230 may be attached to a support member 240 (e.g., the support member 240 of FIG. 4). In one embodiment, at least a portion of the display 230 may be disposed so as to be accommodated in a bendable manner into the first space 2101 of the first housing 210 while being supported by the support member (e.g., the support member 240 of FIG. 4) in a slide-in state so as to be invisible from the outside. In one embodiment, at least a portion of the display 230 may be disposed so as to be visible from the outside while being supported by the support member (e.g., the support member 240 of FIG. 4) that forms at least partially the same plane as the second housing 220 in a slide-out state.

According to some embodiments, the electronic device 101 may include a first housing 210 including a first lateral member 211 and a second housing 220 including a second lateral member 221. In one embodiment, the first lateral member 211 may include a first side surface 2111 having a first length along a first direction (e.g., y-axis direction), a second side surface 2112 extending from the first side surface 2111 to have a second length along a direction substantially perpendicular to the first side surface 2111 and shorter than the first length, and a third side surface 2113 extending from the second side surface 2112 substantially parallel to the first side surface 2111 and having the first length. In one embodiment, the first lateral member 211 may be formed at least partially of a conductive material (e.g., a metal). In some embodiments, the first lateral member 211 may be formed by combining a conductive member and a non-conductive member (e.g., a polymer). In one embodiment, the first housing 210 may include a first extension member 212 extending from at least a portion of the first lateral member 211 to at least a portion of the first space 2101. In one embodiment, the first extension member 212 may be formed integrally with the first lateral member 211. In some embodiments, the first extension member 212 may be formed separately from the first lateral member 211 and structurally coupled to the first lateral member 211.

According to other embodiments, the second lateral member 221 may include a fourth lateral member 2211 that corresponds at least partially with the first lateral member 2111 and has a third length, a fifth lateral member 2212 that extends from the fourth lateral member 2211 in a direction substantially parallel to the second lateral member 2112 and has a fourth length that is shorter than the third length, and a sixth lateral member 2213 that extends from the fifth lateral member 2212 to correspond with the third lateral member 2113 and has a third length. In one embodiment, the second lateral member 221 may be formed at least partially of a conductive member (e.g., a metal). In some embodiments, the second lateral member 221 may be formed by combining a conductive member and a non-conductive member (e.g., a polymer). In one embodiment, at least a portion of the second lateral member 221 may include a second extension member 222 that extends to at least a portion of the second space 2201 of the second housing 220. In one embodiment, the second extension member 222 may be formed integrally with the second lateral member 221. In some embodiments, the second extension member 222 may be formed separately from the second lateral member 221 and structurally coupled to the second lateral member 221.

According to various embodiments, the first side surface 2111 and the fourth side surface 2211 may be slidably coupled with respect to one another. In one embodiment, the third side surface 2113 and the sixth side surface 2213 may be slidably coupled with respect to one another. In one embodiment, in the slide-in state, the fourth side surface 2211 may be disposed to overlap with the first side surface 2111 so as to be substantially invisible from the outside. In another embodiment, in the slide-in state, the sixth side surface 2213 may be disposed to overlap with the third side surface 2113 so as to be substantially invisible from the outside. In some embodiments, at least a portion of the fourth side surface 2211 and the sixth side surface 2213 may be disposed to be at least partially visible from the outside in the slide-in state. In one embodiment, in the slide-in state, the second extension member 222 may be disposed to overlap with the first extension member 212 so as to be substantially invisible from the outside. In some embodiments, the second extension member 222 may be disposed to be at least partially visible from the outside in the slide-in state.

The first housing 210 may include a first rear cover 213 coupled with at least a portion of the first lateral member 211. In one embodiment, the first rear cover 213 may be disposed in a manner such that it couples with at least a portion of the first extension member 212. In some embodiments, the first rear cover 213 may be formed integrally with the first lateral member 211. In one embodiment, the first rear cover 213 may be formed of a polymer, a coated or colored glass, a ceramic, a metal (e.g., aluminum, stainless steel (STS), or magnesium), or a combination of at least two of these materials. In some embodiments, the first rear cover 213 may extend to at least a portion of the first lateral member 211. In some embodiments, the first rear cover 213 may be omitted and at least a portion of the first extension member 212 may be replaced with the first rear cover 213.

According to various embodiments, the second housing 220 may include a second rear cover 223 coupled with at least a portion of the second lateral member 221. In one embodiment, the second rear cover 223 may be disposed in a manner such that it couples with at least a portion of the second extension member 222. In some embodiments, the second rear cover 223 may be formed integrally with the second lateral member 221. In one embodiment, the second rear cover 223 may be formed of a polymer, a coated or colored glass, a ceramic, a metal (e.g., aluminum, stainless steel (STS), or magnesium), or a combination of at least two of these materials. In some embodiments, the second rear cover 223 may extend to at least a portion of the second lateral member 221. In some embodiments, the second rear cover 223 may be omitted and at least a portion of the second extension member 222 may be replaced with the second rear cover 223.

The display 230 may include a first portion 230a (e.g., a flat portion) that is always visible from the outside and a second portion 230b (e.g., a bendable portion or a bending portion) that extends from the first portion 230a and is accommodated in a manner that is at least partially bent into the first space 2101 of the first housing 210 so as not to be visible from the outside in a slide-in state. In another embodiment, the first portion 230a may be disposed to be supported by the second housing 220, and the second portion 230b may be disposed to be at least partially supported by a support member (e.g., the support member 240 of FIG. 4). In one embodiment, the second part 230b of the display 230 may be disposed to form substantially the same plane as the first part 230a and be visible from the outside while being supported by a support member (e.g., the support member 240 of FIG. 4) when the second housing 220 is in a slide-out state along the first direction (direction \textcircled{1}). In one embodiment, the second part 230b of the display 230 may be accommodated in a manner of bending into the first space 2101 of the first housing 210 when the second housing 220 is in a slide-in state along the second direction (direction \textcircled{2}) and may be disposed so as not to be visible from the outside. Accordingly, the display area of the display 230 may be varied as the second housing 220 is moved in a sliding manner along a specified direction (e.g., ±y-axis direction) from the first housing 210.

According to various embodiments, the length of the display 230 in a first direction (direction \textcircled{1}) may be varied according to the sliding movement of a second housing 220 relative to a first housing 210. In an example, the display 230, in a slide-in state, may have a first display area (e.g., an area corresponding to the first portion 230a) corresponding to a first length L1. In one embodiment, the display 230, in a slide-out state, may be expanded to have a second display area (e.g., an area including the first portion 230a and the second portion 230b) corresponding to a third length L3 longer than the first length L1 and larger than the first display area according to the sliding movement of the second housing 220 that is additionally moved by a second length L2 relative to the first housing 210.

According to other embodiments, the electronic device 101 may include at least one of an input device (e.g., a microphone 203-1), an audio output device (e.g., a call receiver 206 and/or a speaker 207), a sensor module 204 and 217, socket module 218, a camera module (e.g., a first camera module 205 or a second camera module 216), a connector port 208, a key input device 219, or an indicator (not shown) disposed in the second space 2201 of the second housing 220. In one embodiment, the electronic device 101 may include another input device (e.g., a microphone 203) disposed in the first housing 210. In some embodiments, the electronic device 101 may be configured such that at least one of the above-described components is omitted, or other components are additionally included. In some embodiments, at least one of the above-described components may be disposed in the first space 2101 of the first housing 210.

According to various embodiments, the input device may include a microphone 203-1. In some embodiments, the input device (e.g., microphone 203-1) may include a plurality of microphones disposed to detect the direction of sound. The audio output device may include, for example, a call receiver 206 and a speaker 207. In one embodiment, the speaker 207 may be connected to the outside through at least one speaker hole formed in the second housing 220 in a position that is always exposed to the outside (e.g., fifth side surface 2212), regardless of the slide-in/slide-out state. In one embodiment, the connector port 208 may be connected to the outside through a connector port hole formed in the second housing 220 in the slide-out state. In some embodiments, the connector port 208 may be connected to the outside through an opening formed in the first housing 210 in the slide-in state and connected to the connector port hole. In some embodiments, the call receiver 206 may include a speaker (e.g., a piezo speaker) operating without a separate speaker hole.

The sensor modules 204 and 217 may generate electrical signals or data values corresponding to the internal operating state of the electronic device 200 or the external environmental state. In one embodiment, the sensor modules 204 and 217 may include, for example, a first sensor module 204 (e.g., a proximity sensor or an ambient light sensor) disposed on the front surface of the electronic device 200 and/or a second sensor module 217 (e.g., a heart rate monitoring (HRM) sensor) disposed on the rear surface of the electronic device 200. In one embodiment, the first sensor module 204 may be disposed below the display 230 on the front surface of the electronic device 200. In one embodiment, the first sensor module 204 and/or the second sensor module 217 may include at least one of a proximity sensor, an ambient light sensor, a time of flight (TOF) sensor, an ultrasonic sensor, a fingerprint recognition sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, or a humidity sensor.

According to other embodiments, the camera module may include a first camera module 205 disposed on the front surface of the electronic device 200 and a second camera module 216 disposed on the rear surface of the electronic device 200. In one embodiment, the electronic device 101 may also include a flash (not shown) positioned near the second camera module 216. In one embodiment, the camera modules 205 and 216 may include one or more lenses, an image sensor, and/or an image signal processor. In one embodiment, the first camera module 205 may be disposed under the display 230 and configured to capture an object through a portion of an active area (e.g., a display area) of the display 230.

According to various embodiments, the first camera module 205 among the camera modules and some of the sensor modules 204 among the sensor modules 204 and 217 may be disposed to detect the external environment through the display 230. For example, the first camera module 205 or some of the sensor modules 204 may be disposed in the second space 2201 of the second housing 220 so as to be in contact with the external environment through a transparent area or a perforated opening formed in the display 230. In one embodiment, an area of the display 230 facing the first camera module 205 may be formed as a transparent area having a designated transmittance as part of an active area for displaying content. In one embodiment, the transparent area may be formed to have a transmittance in a range of about 5% to about 20%. This transparent area may include an area overlapping with the effective area (e.g., field of view area) of the first camera module 205 through which light passes to be imaged by the image sensor to create an image. For example, the transparent area of the display 230 may include an area with a lower pixel arrangement density and/or wiring density than the surrounding area. For example, the transparent area may be replaced with the opening described above. For example, some camera modules 205 may include an under-display camera (UDC). In some embodiments, some sensor modules 204 may be disposed to perform their functions in the second space 2201 of the second housing 220 without being visually exposed through the display 230.

The electronic device 101 may include at least one antenna element (e.g., the antenna element 224b of FIG. 4) electrically connected to a wireless communication circuit (e.g., the wireless communication module 192 of FIG. 1) disposed in an inner space (e.g., the second space 2201 of the second housing 220). In one embodiment, the electronic device 101 may include a bezel antenna A disposed through at least a portion of a conductive first lateral member 211 of the first housing 210. For example, the bezel antenna A may include a conductive portion 227 (e.g., a conductive member) disposed through at least a portion of a second side surface 2112 and a third side surface 2113 of the first lateral member 211 and electrically segmented through at least one segmentation portion 2271 and 2272 formed of a non-conductive material (e.g., a polymer). In an embodiment, a wireless communication circuit (e.g., a wireless communication module 192 of FIG. 1) may be configured to transmit or receive a wireless signal in at least one frequency band (e.g., about 600 MHz to 9000 MHz) (e.g., a legacy band or an NR band) designated through a conductive portion 227. In one embodiment, the electronic device 101 may include a side cover 2112a disposed on the second side surface 2112 to cover at least a portion of at least one segmentation portion 2271. In some embodiments, the bezel antenna A may be disposed on at least one of the first side surface 2111, the second side surface 2112, or the third side surface 2113. In some embodiments, the bezel antenna A may be disposed on at least one of the fourth side surface 2211, the fifth side surface 2212, or the sixth side surface 2213 of the second housing 220. In some embodiments, the electronic device 101 may further include at least one antenna module (e.g., mmWave antenna module or mmWave antenna structure) disposed in an inner space (e.g., first space 2101 or second space 2201) and disposed to transmit or receive a wireless signal in a frequency band ranging from about 3 GHz to 100 GHz through another wireless communication circuit (e.g., the wireless communication module 192 of FIG. 1).

The slide-in/slide-out operation of the electronic device 200 may be performed automatically. For example, the slide-in/slide-out operation of the electronic device 200 may be performed through gear engagement between a driving motor (e.g., the driving motor 260 of FIG. 4) including a pinion gear (e.g., the pinion gear 261 of FIG. 4) disposed in a first space 2101 of the first housing 210 and a rack gear (e.g., the rack gear 2221 of FIG. 4) disposed in a second space 2201 of the second housing 220 and gear-engaged with the pinion gear 261. In some embodiments, a driving motor 260 including a pinion gear 261 may be disposed in a second space 2201 of a second housing 220, and a rack gear 2221 coupled with the pinion gear 261 may be disposed in a first space 2101 of a first housing 210. For example, a processor of the electronic device 200 (e.g., the processor 120 of FIG. 1) may operate a driving motor (e.g., the driving motor 260 of FIG. 4) disposed inside the electronic device 200 when detecting a triggering signal for changing from a slide-in state to a slide-out state or from a slide-out state to a slide-in state. In one embodiment, the triggering signal may include a signal according to selection (e.g., touch) of an object displayed on the display 230 or a signal according to operation of a physical button (e.g., a key button) included in the electronic device 200. In some embodiments, the slide-in/slide-out operation of the electronic device 200 may be performed manually through user operation.

According to various embodiments, the electronic device 101 may have a structure in which the second housing 220 slides in and/or out relative to the first housing 210 along the longitudinal direction (e.g., vertical direction) (e.g., ±y-axis direction) of the electronic device 200, but is not limited thereto. In an example, the electronic device 101 may have a structure in which the second housing 220 slides in and/or out relative to the first housing 210 along the width direction (e.g., horizontal direction) (e.g., ±x-axis direction) perpendicular to the longitudinal direction of the electronic device 200. In some embodiments, the electronic device 101 may be formed such that the length of the second side surface 2112 of the first housing 210 is longer than the length of the first side surface 2111. In this case, the length of the fifth side surface 2212 of the second housing 220 may also be formed to be longer than the length of the fourth side surface 2211.

FIG. 4 is an exploded perspective view of an electronic device according to an embodiment of the disclosure.

In describing the electronic device 200 of FIG. 4, the same symbols are given to components that are substantially the same as those of the electronic devices 200 of FIGS. 2A, 2B, 3A, and 3B, and a detailed description thereof may be omitted.

Referring to FIG. 4, the electronic device 101 may include a first housing 210 including a first space 2101, a second housing 220 slidably coupled from the first housing 210 and including a second space 2201, a support member 240 fixed to at least a portion of the second housing 220 and at least partially bendably accommodated into the first space 2101 according to a slide-in operation, a display 230 disposed to be supported by at least a portion of the support member 240 and the second housing 220, and a drive module (e.g., a drive mechanism) that drives the second housing 220 from the first housing 210 in a slide-in direction (e.g., −y-axis direction) and/or a slide-out direction (e.g., y-axis direction). In one embodiment, the first housing 210 may include a first lateral member 211 and a first rear cover 213 coupled with at least a portion of the first lateral member 211 (e.g., at least a portion of the first extension member 212). In an embodiment, the second housing 220 may include a second lateral member 221 and a second rear cover 223 coupled with at least a portion of the second lateral member 221 (e.g., at least a portion of the second extension member 221). In one embodiment, the drive module may be disposed in the first space 2101 and include a driving motor 260 including a pinion gear 261 and a rack gear 2221 disposed in gear engagement with the pinion gear 261 in the second space 2201. In one embodiment, the drive module may further include a reduction module (e.g., a reduction gear assembly) disposed to reduce the rotational speed and increase the driving force by being coupled with the driving motor 260. In one embodiment, the driving motor 260 may be disposed to be supported by a motor bracket 260a disposed on a support bracket 225 disposed in a first space 2101 of the first housing 210. In one embodiment, the driving motor 260 may be fixed to an end (e.g., an edge) of the support bracket 225 in a slide-out direction (e.g., y-axis direction) in the first space 2101. In one embodiment, the rack gear 2221 may be disposed in such a manner that it is fixed to a second extension member 222 of the second housing 220. In some embodiments, the rack gear 2221 may be integrally formed by injection-molding at least a portion of the second extension member 222. In one embodiment, the rack gear 2221 may be disposed to have a length in a direction parallel to the sliding direction (e.g., ±y-axis direction). Accordingly, when the electronic device 200 is assembled, the pinion gear 261 may maintain a state of gear engagement with the rack gear 2221, and the pinion gear 261, which receives the driving force of the driving motor 260, may move along the rack gear 2221, thereby causing the second housing 220 to move relative to the first housing 210. In one embodiment, the sliding distance of the second housing 220 may be determined by the length of the rack gear 2221.

According to other embodiments, the electronic device 101 may include a plurality of electronic components disposed in a second space 2201. In one embodiment, the plurality of electronic components may include a first substrate 251 (e.g., a main substrate), a camera module 216, a speaker 207, a connector port 208, and a microphone 203-1 disposed around the first substrate 251. In one embodiment, the plurality of electronic components may be disposed around the first substrate 251 in the second space 2201 of the first housing 210, thereby enabling efficient electrical connection. In some embodiments, at least one of the plurality of electronic components described above may be disposed in the first space 2101 of the first housing 210.

According to still other embodiments, the electronic device 101 may include a rear bracket 224 disposed between a second extension member 222 and a second rear cover 223 in a second housing 220. In one embodiment, the rear bracket 224 may be disposed to cover at least a portion of a plurality of electronic components. In one embodiment, the rear bracket 224 may be structurally coupled to at least a portion of the second extension member 222. In some embodiments, the rear bracket 224 may be omitted. In one embodiment, the rear bracket 224 may be disposed to cover a plurality of electronic components and support the second rear cover 223. In one embodiment, the rear bracket 224 may include an opening 224a (e.g., a through hole) or a notch area 224c (e.g., a cutting portion) formed in an area corresponding to a camera module 216 and/or a sensor module (e.g., a sensor module 217 of FIG. 3B). In one embodiment, the rear bracket 224 may include at least one antenna element 224b. In one embodiment, the at least one antenna element 224b may be disposed on an outer surface when the rear bracket 224 is formed as an injection-molded article of a dielectric material (e.g., an antenna carrier). In one embodiment, the at least one antenna element 224b may include a laser direct structuring (LDS) antenna pattern formed on an outer surface of the rear bracket 224. In some embodiments, at least one antenna element 224b may include a conductive plate attached to the outer surface of the rear bracket 224, a conductive paint formed on the outer surface, or a conductive pattern. In some embodiments, at least one antenna element 224b may be disposed in a manner that is built in when the rear bracket 224 is injected. In one embodiment, at least one antenna element 224b may be configured to transmit or receive a wireless signal in a designated frequency band (e.g., a legacy band) by being electrically connected to a wireless communication circuit (e.g., the wireless communication module 192 of FIG. 1) disposed on the first substrate 251. In one embodiment, a camera module 216 and/or a sensor module 217 may be disposed to detect the external environment through the opening 224a or the notch area 224a. In one embodiment, the second rear cover 223 may be transparent at least in an area corresponding to the camera module 216 and/or the sensor module 217. In some embodiments, the second rear cover 223 may include a through hole formed in an area corresponding to at least the camera module 216 and/or the sensor module 217. In this case, the through hole may be covered by a transparent window. In some embodiments, the camera module 216 and/or the sensor module 217 may be configured to operate only when the electronic device 200 is in a slide-out state.

The electronic device 101 may include a support bracket 225 disposed in a first space 2101 of a first housing 210. In one embodiment, the support bracket 225 may include a support portion 2252 having a curved outer surface to support a rear surface of a support member 240 that is disposed at one end and is bent during a sliding operation transitioning from a slide-out state to a slide-in state. In one embodiment, the support bracket 225 may include a support structure for supporting and fixing a driving motor 260 through a motor bracket 260a. In one embodiment, the support bracket 225 may include a battery mounting portion 2251 for accommodating a battery. In an embodiment, the driving motor 260 may be disposed at the farthest end (e.g., an edge) of the support bracket 225 in the slide-out direction (e.g., y-axis direction). For example, when the assembly of the electronic device 200 is completed, the driving motor 260 may be disposed at a position closest to the first substrate 251 among the electronic components disposed in the first housing 210, thereby helping to minimize the size and/or length of the flexible substrate F1 (e.g., flexible printed circuit board (FPCB)) that electrically connects the first substrate 251 and the driving motor 260. In one embodiment, the electronic device 101 may include a pair of guide rails 226 disposed on both sides of the support bracket 225 to guide both ends of the support member 240 in the sliding direction.

According to various embodiments, the first housing 210 may include an opening 212a (e.g., a through hole) disposed in an area corresponding to a camera module 216 and/or a sensor module 217 disposed in the second housing 220 when the electronic device 200 is in a slide-in state in the first extension member 212. In one embodiment, the camera module 216 and/or the sensor module 217 may detect an external environment through the opening 212a formed in the first housing 210 when the electronic device 200 is in a slide-in state. In some embodiments, the area corresponding to the camera module 216 and/or the sensor module 217 of the first rear cover 213 may be processed to be transparent.

The electronic device 101 may include a second substrate 252 (e.g., a sub-substrate) and an antenna member 253 disposed between a first extension member 212 and a first rear cover 213 in a first housing 210. In one embodiment, the second substrate 252 and the antenna member 253 may be disposed on at least a portion of the first extension member 212. In one embodiment, the second substrate 252 and the antenna member 253 may be electrically connected to the first substrate 251 through at least one electrical connection member (e.g., a flexible printed circuit board (FPCB) or a flexible RF cable (FRC)). In one embodiment, the antenna member 253 may include a multi-function coil (MFC) or multi-function core (MFC) antenna for performing a wireless charging function, a near field communication (NFC) function, and/or an electronic payment function. In some embodiments, the antenna member 253 may be electrically connected to the second substrate 252, thereby being electrically connected to the first substrate 251 through the second substrate 252. In some embodiments, the second substrate 252 and/or the antenna member 253 may be electrically connected to the first substrate 251 through at least a portion of a flexible substrate F1 connecting the driving motor 260 and the first substrate 251.

The support member 240 may be guided by the guide rail 226 during the slide-in/slide-out operation. In one embodiment, the support member 240 may include a plurality of multi-bars 241 that are rotatably coupled with respect to each other and guide protrusions 2411 that are protruded at both ends of each of the multi-bars 241. In one embodiment, the guide rail 226 may include a guide slit 2261 that is formed at a position corresponding to the movement trajectory of the support member 240. In one embodiment, when the support member 240 that is fixed in a manner of being attached to the rear surface of the display 230 is movably coupled with the guide rail 226, the guide protrusions 2411 may move along the guide slits 2611, thereby helping to reduce the phenomenon of the display 230 being detached or deformed during operation.

The electronic device 101 according to various embodiments may be applied to various electronic devices (e.g., a rollable electronic device, a slidable electronic device, a camera device) including a driving unit (e.g., a driving motor) configured to change the electronic device 101 into a first state by moving (or sliding-out) some components of the electronic device 101 using a rotational force, or to change the electronic device 101 into a second state in which some components of the electronic device 101 are seated back (or slid-in, coupled, or joined tightly) differently from the first state through reverse rotation.

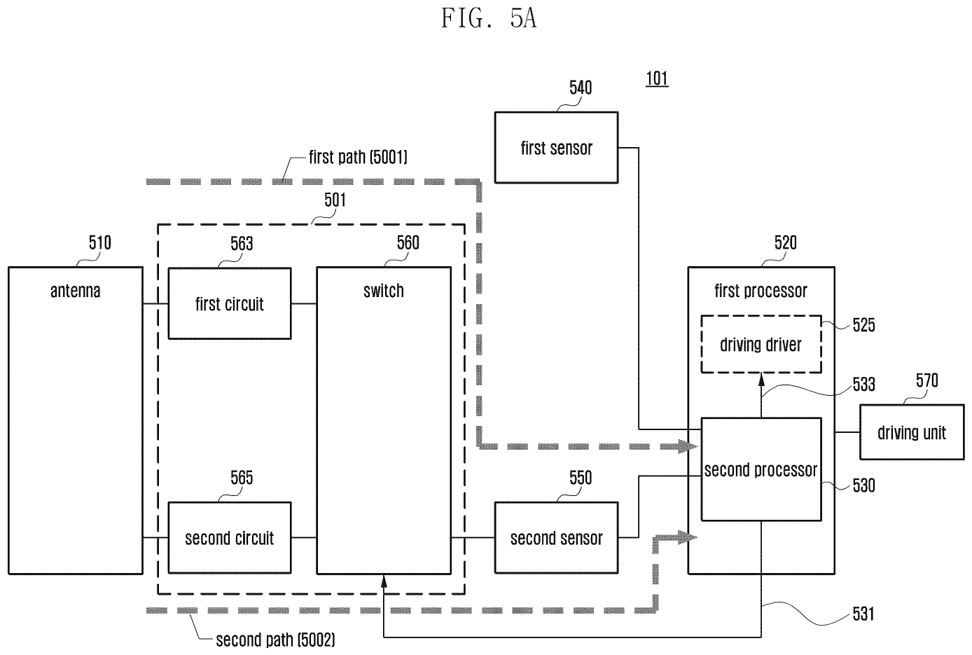

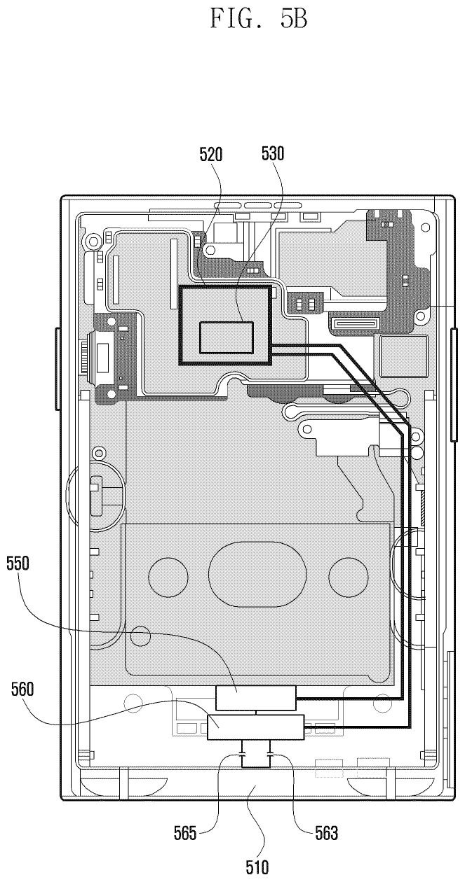

FIG. 5A illustrates a block diagram of an electronic device including a sensor switch according to an embodiment of the disclosure, and FIG. 5B illustrates a layout diagram of some components of the electronic device illustrated in FIG. 5A according to an embodiment of the disclosure.

Referring to FIGS. 5A and 5B, an electronic device 101 according to one embodiment (e.g., the electronic device of FIG. 1, the electronic device 101 of FIGS. 2A, 2B, 3A, 3B, and 4) may include an antenna 510 (e.g., the antenna module 197 of FIG. 1), a first processor 520 (e.g., the main processor 121 of FIG. 1), a second processor 530 (e.g., the auxiliary processor 123 of FIG. 1), a first sensor 540 (e.g., the sensor module 176 of FIG. 1, the first sensor module 204 and/or the second sensor module 217 of FIGS. 2A and 2B), a second sensor 550 (e.g., the sensor module 176 of FIG. 1, the first sensor module 204 and/or the second sensor module 217 of FIGS. 2A and 2B), and a driving unit 570 (e.g., the driving motor 260 of FIG. 4)). The sensor switch 501 may be referred to as including, but not limited to, a first circuit 563, a second circuit 565, and a switch 560. The electronic device 101 of FIGS. 5A and 5B may include the entire configuration or a portion of the configuration illustrated in FIG. 1.

The antenna 510 may include at least one antenna radiator (e.g., the antenna element 224b of FIG. 4, bezel antenna A) made of a conductive member (or conductive pattern). The antenna radiator may be designed to transmit and receive wireless signals of the same band or different bands.

According to one embodiment, the electronic device 101 may include a metal member (e.g., a bezel portion of a housing, a side metal frame) used in some configuration of the electronic device 101. For example, the metal member may be designed to be used as an antenna radiator. The metal member may be disposed at various locations of the electronic device 101. The metal member included in the electronic device 101 may be connected to a second sensor 550 and may be used as a sensing member of the second sensor 550.

Although the embodiment of FIG. 5B illustrates that the antenna 510 is disposed at the lower end of the electronic device 101, it is not limited thereto. Referring to FIG. 5B, the first processor 520 and the second processor 530 may be disposed on a main board (e.g., a main printed circuit board), and the antenna 510, the first circuit 563, the second circuit 565, and the second sensor 550 may be disposed on a sub board (e.g., a sub printed circuit board), but it is not limited thereto. In another embodiment, the second processor 530 may be disposed on the sub board as a separate hardware configuration physically distinct from the first processor 520.

For example, the antenna 510 may be disposed on the top of the electronic device 101 and/or on the side surface of the electronic device 101. The antenna 510 may be referred to as at least one of a main antenna, a sub antenna, a side surface antenna, a top antenna, a bottom antenna, and a bezel antenna, depending on the disposition location and/or function of the antenna 510.

According to one embodiment, the first sensor 540 (e.g., a motion detection sensor or a drop detection sensor) may include various sensors implemented to detect the movement of the electronic device 101. For example, the first sensor 540 may be composed of an acceleration sensor, a gravity sensor, a gyroscope sensor, or a combination thereof. The first sensor 540 may be composed of a 6-axis gyro sensor. The first sensor 540 may be connected to the second processor 530. The first sensor 540 may detect motion information (e.g., a first measurement value) that changes because of the movement of the electronic device 101 and transmit the same to the second processor 530. The second processor 530 may recognize (or determine) a free drop or drop state of the electronic device 101 on the basis of the motion information transmitted from the first sensor 540.

According to one embodiment, the second sensor 550 (e.g., a grip sensor) may include a grip sensor that detects grip information (e.g., a grip state, a grip release state, a grip position) when a user holds or grabs the electronic device 101.

According to another embodiment, the second sensor 550 may be operatively connected to the antenna 510 or the metal member of the electronic device 101, and a switch 560 (e.g., a sensor switch, a grip sensor switch) may be disposed between the second sensor 550 and the antenna 510 (or the metal member). A first input terminal of the switch 560 may be connected to the antenna 510 through a first circuit 563, a second input terminal may be connected to the antenna 510 through a second circuit 565, and an output terminal of the switch 560 may be connected to the second sensor 550. For example, the first circuit 563, the second circuit 565, and the switch 560 may be referred to as a sensor switch 501, but it is not limited thereto. The sensor switch 501 may also be implemented as some components of the second sensor 550.

According to one embodiment, when a user grips or holds an electronic device 101, the second sensor 550 may detect proximity or contact of a part of the user's body (e.g., the user's hand) according to the gripping action, and transmit grip information (e.g., a second measurement value or a third measurement value) including an antenna change amount (or a capacitance change amount) changed by the part of the user's body to the second processor 530. For example, when a user grips or holds an electronic device, the capacitance value may change as the antenna's reception signal strength or power value decreases.

According to another embodiment, the second processor 530 may obtain a second measurement value from a second sensor 550 connected to a second circuit 565, and may obtain a third measurement value from a second sensor 550 connected to a first circuit 563. The second processor 530 may recognize (or determine) at least one of an electronic device grip state, a grip release state, or a grip position through grip information (e.g., the second measurement value or the third measurement value) transmitted from the second sensor 550. According to one embodiment, the second sensor 550 may be disposed in various locations (or areas) such as left and right side surfaces, upper and lower side surfaces, and a rear side surface of the electronic device 101.

The switch 560 may be connected to the second processor 530 and may be switched to connect the antenna 510 and the second sensor 550 through the first circuit 563 (e.g., the first path 5001) or to connect the antenna 510 and the second sensor 550 through the second circuit 565 (e.g., the second path 5002). For example, when a first level signal (e.g., a low level signal) is transmitted from the second processor 530, the switch 560 may be switched to connect the first circuit 563 and the second sensor 550, thereby cutting off (or shorting) the connection with the second circuit 565. When a second level signal (e.g., a high level signal) is transmitted from the second processor 530, the switch 560 may be switched to connect the second circuit 565 and the second sensor 550, thereby switching to disconnect the connection of the first circuit 563.

The first circuit 563 (or the first path 5001) and the second circuit 565 (or the second path 5002) may be designed to have different sensing features (e.g., capacitance difference, sensing cycle, sensing speed, recognition distance, delay time). For example, the first circuit 563 may be designed for the purpose of recognizing whether the electronic device 101 is in contact with the user's body for specific absorption rate (SAR) control (or grip recognition for SAR control). For example, the electronic device 101 may be controlled to lower the SAR by adjusting the transmission power of the antenna 510 when the electronic device is in contact with the user's body. The second circuit 565 may be designed for the purpose of recognizing a grip signal for determining whether or not there has been a drop (or grip recognition for drop state monitoring, or drop detection misrecognition solution).

The first path 5001 may refer to a sensing path for grip recognition for SAR control, and the second path 5002 may refer to a sensing path for monitoring to determine a drop state.

According to one embodiment, the time constants or software tuning values (or sensor recognition configuration values) of the passive components (e.g., capacitors, resistors and/or inductors) included in the first circuit 563 (or the first path 5001) and the second circuit 565 (or the second path 5002) may have different values depending on the electrical path usage. For example, the capacitance of the capacitors included in the first circuit 563 and the capacitors included in the second circuit 565 may have different values.

According to an embodiment, the sensing cycle for determining the grip state for SAR control using the first circuit 563 may be different from the sensing cycle for determining the grip state for monitoring the drop state using the second circuit 565. For example, the first circuit 563 (e.g., the first path 5001 designed for grip recognition for SAR control) may have a time constant value or a tuning value (e.g., path length) of a passive element configured so that the grip state is recognized at a recognition distance of 10 mm or less and at a cycle of 100 ms from the user's body, and the second circuit 565 (e.g., the second path 5002 designed for grip recognition for drop state determination) may have a time constant value or a tuning value of a passive element configured so that the grip state is recognized at a recognition distance of 10 m or more and at a cycle of 40 ms, but this is an example and is not limited thereto.

According to another embodiment, the sensing features resulting from the first circuit 563 (or first path 5001) and the sensing features resulting from the second circuit 565 (or second path 5002) may be logically switched within at least one integrated circuit.

According to one embodiment, the first processor 520 may control hardware or software components connected to the first processor 520 by running an operating system or application program, and may perform various data processing and operations.

The second processor 530 may be implemented as a part of the first processor 520 (e.g., as a single chip). The second processor 530 may be disposed in a logically separate area within the first processor 520, and the first processor 520 and the second processor 530 may be integrated into a single chip. Although not shown in the drawing, the first processor 520 may further include a graphics processing unit, a neural processing unit (NPU), an image signal processor, or a communication processor in addition to the second processor 530.

In one embodiment, the first processor 520 may be referred to as a high-power processor, a high-performance processor, or a main processor, and the second processor 530 may be referred to as a sub-processor, an auxiliary processor, a low-power processor, a low-performance processor, or a sensor processor. The electronic device 101 may control functions or operations related to the first sensor 540 and the second sensor 550 by activating only the area (or block) allocated to the second processor 530 within the first processor 520.

According to one embodiment, the second processor 530 may control the switch 560 to selectively connect the antenna 510 and the second sensor 550 through the first circuit 563 or the second circuit 565. The second processor 530 may be connected to the switch 560 through the first wiring 531 and to the driving driver 525 included in the kernel (or hardware abstraction layer) within the first processor 520 through the second wiring 533.

The electronic device 101 may support a function in which some components of the electronic device 101 are moved using a rotational force, thereby changing the electronic device 101 into a first state, or switching to a second state in which some components of the electronic device 101 are coupled (or seated back, joined tightly) through reverse rotation. The first state may include at least one of a slide-out state, a motor-driven state, a rollable-out state, an electronic device-open state, and/or a camera lens-driven state, and the second state may include at least one of a slide-in state, a motor reverse-rotation state, a rollable-in state, an electronic device-closed state, and/or a camera lens-closed state.

According to one embodiment, the second processor 530 and/or the first processor 520 may recognize a first state of the electronic device 101 in which some components of the electronic device 101 are moved using rotational force. For example, the electronic device 101 may recognize a change from a slide-in state to a slide-out state (or a first state, a motor-driven state, a rollable-out state, an electronic device-opened state, a camera lens-driven state) as illustrated in FIGS. 2A, 2B, 3A, and 3B.

The second processor 530 may transmit a first level signal (e.g., a low level signal) or a second level signal (e.g., a high level signal) to the switch 560 to control the switch 560 through the first wiring 531. The switch 560 may be switched to connect the first circuit 563 and the second sensor 550 by the first level signal, or may be switched to connect the second circuit 565 and the second sensor 550 by the second level signal.

According to one embodiment, the electronic device 101 may be predetermined to a first mode (e.g., a single mode, a switch single mode, a normal mode, a basic mode) in which the antenna 510 is connected to the second sensor 550 through the first circuit 563 by the second processor 530 transmitting a first level signal to the switch 560 through the first wiring 531.

According to another embodiment, the second processor 530 may determine whether the electronic device 101 is in a grip state on the basis of the second sensor 550 connected to the first circuit 563 and/or the third measurement value transmitted from the first path 5001. When the electronic device 101 is recognized as being in the first state and the electronic device 101 grip state, the second processor 530 may switch to a second mode (e.g., a dual mode, a switching mode, a grip dual mode) that selectively transmits a first level signal or a second level signal through the first wiring 531. For example, in the second mode, the second processor 530 may alternately transmit the first level signal or the second level signal to the switch 560 at regular intervals, or may transmit the first level signal and, when a drop state is recognized, may temporarily transmit the second level signal to the switch 560 for a certain period of time.

When operating in the second mode, the second processor 530 may obtain a third measurement value from the second sensor 550 connected to the first circuit 563 during the first level signal interval and may obtain a second measurement value from the second sensor 550 connected to the second circuit 565 during the second level signal interval. The second processor 530 may distinguish the second measurement value and the third measurement value and store them in memory or a buffer (not shown).

According to one embodiment, the second processor 530 may detect a grip recognition signal for controlling a SAR on the basis of a third measurement value obtained in a first level signal interval and may detect a grip recognition signal for monitoring a drop state on the basis of a second measurement value obtained in a second level signal interval.

According to an embodiment, the second processor 530 may recognize a free drop or drop state of the electronic device 101 on the basis of motion information (e.g., a first measurement value) transmitted from the first sensor 540 when operating in the second mode. For example, after the free drop or drop state of the electronic device is recognized through the first sensor 540, the second processor 530 may obtain a second measurement value in a second level signal interval and determine (or monitor) whether the user is gripping or releasing the electronic device through the obtained second measurement value.

The second processor 530 may recognize a free drop or drop state of the electronic device on the basis of motion information (e.g., a first measurement value) transmitted from the first sensor 540, and then, when the user has released the grip of the electronic device 101 on the basis of a second measurement value obtained in a second level signal interval, determine the free drop or drop state and transmit a driving interrupt signal to the first processor 520 in order to reduce misrecognition of whether the electronic device is dropping. For example, the driving interrupt signal may be transmitted to a driving driver 525 included in a logical block (e.g., a kernel, a hardware abstraction layer)) of the first processor 520 through the second wiring 533.

The second processor 530 according to one embodiment may control the switch 560 so that one of the first circuit 563 and the second circuit 565 is electrically connected to the antenna on the basis of the identified first measurement value and the identified second measurement value in a first state in which at least a portion of the display is withdrawn from the housing using a driving unit (e.g., a driving motor) 570.

According to one embodiment, the electronic device 101 may recognize a free drop or drop state of the electronic device on the basis of motion information (e.g., a first measurement value) transmitted from a first sensor 540, and then transmit a driving interrupt signal to the first processor 520 only under a condition where the user has determined that the electronic device is in a grip release state on the basis of a second signal obtained in a second level signal interval, thereby not only preventing misrecognition of the drop by monitoring the state of the electronic device being dropped, but also reducing the latency until the motor is driven.

According to an embodiment, the first processor 520 may control the driving unit (e.g., driving motor) 570 through a logical block including a driving driver 525 in response to a driving interrupt signal to change (or transition) the electronic device 101 from a first state (e.g., a state in which some components of the electronic device 101 are moved) to a second state (e.g., a state in which some components of the electronic device 101 are coupled (or seated back, joined tightly)). For example, the first processor 520 may reversely rotate the driving unit (e.g., driving motor) 570 on the basis of the driving interrupt signal to transition the electronic device 101 from the first state to the second state. In the second state in which some components of the electronic device 101 are internally bonded, rather than in the first state in which some components of the electronic device 101 are moved, the electronic device may be formed with a structure that is more firmly supported against impact than in the first state, so that damage because of impact may be prevented when the electronic device is freely dropped.

According to another embodiment, the second processor 530 may recognize a free drop or drop state of the electronic device on the basis of motion information (e.g., a first measurement value) transmitted from the first sensor 540, and then, on the basis of a second measurement value obtained in a second level signal interval, when the grip of the electronic device 101 is not released or the grip state is maintained, determine a free drop or drop state as a misrecognition and may not generate a driving interrupt signal, or ignore the recognition of the drop state and maintain the drop detection malfunction solution function.

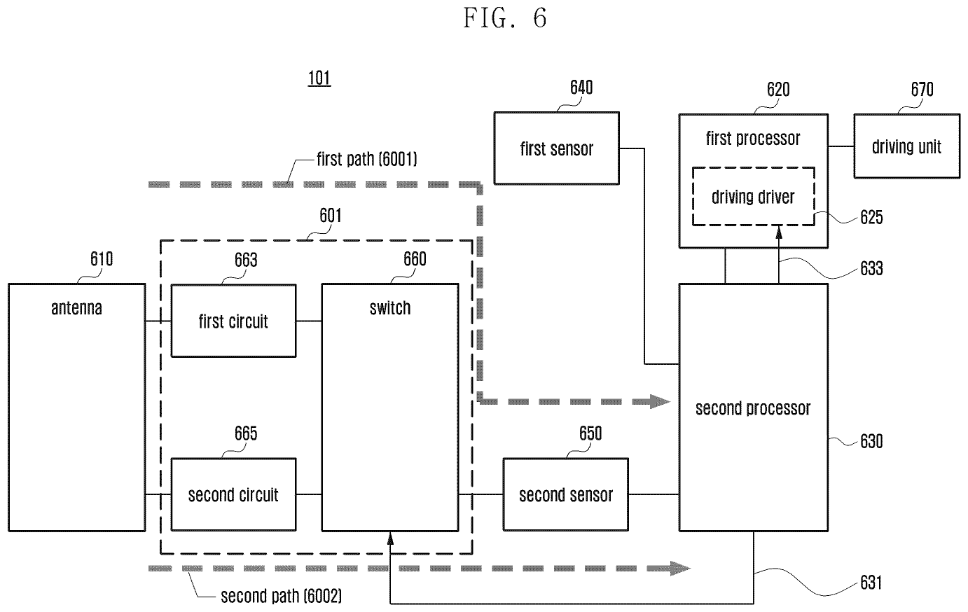

FIG. 6 illustrates a block diagram of an electronic device including a sensor switch according to an embodiment of the disclosure.

Referring to FIG. 6, an electronic device 101 according to one embodiment (e.g., the electronic device of FIG. 1, the electronic device 101 of FIGS. 2A, 2B, 3A, and 3B) may include an antenna 610, a first processor 620, a second processor 630, a first sensor 640, a second sensor 650, a first circuit 663, a second circuit 665, a switch 660, and a driving unit 670. The sensor switch 601 may be referred to as including, but not limited to, the first circuit 663, the second circuit 665, and the switch 660. The sensor switch 601 may also be implemented as some components of the second sensor 650.

The electronic device 101 of FIG. 6 may include the entire configuration or a part of the configuration illustrated in FIG. 1. Since the configurations of the electronic device 101 of FIG. 6 are substantially the same as the configurations illustrated in the antenna 510, the first sensor 540, the second sensor 550, the first circuit 563, the second circuit 565, the switch 560, and the driving unit 570 of FIG. 5A, the functions and/or features of each component will be omitted. In the embodiment of FIG. 6, the second processor 630 may be designed as separate hardware, physically separated from the first processor 620. The second processor 630 may be connected to the switch 660 through a first wiring 631, and may be connected to the driver 625 included in the logical block (e.g., kernel, hardware abstraction layer) of the first processor 620 through a second wiring 633.

An electronic device 101 according to one embodiment may include a housing (e.g., the first housing 210, the second housing 220), an antenna (e.g., the antenna module 197 of FIG. 1, the antenna 510 of FIGS. 5A and 5B, the antenna 610 of FIG. 6), a display (e.g., the display module 160 of FIG. 1, the display 230 of FIGS. 2A, 2B, 3A, 3B, and 4), a driving unit (e.g., the driving motor 260 of FIG. 4, the driving unit 570 of FIG. 5A, the driving unit 670 of FIG. 6) for moving at least a portion of the display, a first sensor that identifies a first measurement value for detecting motion information of the electronic device 101 (e.g., the first sensor 540 of FIG. 5A, the first sensor 640 of FIG. 6), a second sensor that identifies a second measurement value for detecting grip information of the electronic device (e.g., the second sensor 550 of FIGS. 5A and 5B, the second sensor 650 of FIG. 6), a first circuit (e.g., the first circuit 563 of FIGS. 5A and 5B, the first circuit 663 of FIG. 6) and a second circuit (e.g., the second circuit 565, the second circuit 665 of FIG. 6) that are selectively connectable to the second sensor, a switch (e.g., the switch 560 of FIGS. 5A and 5B, the switch 660 of FIG. 6) that allows one of the first circuit and the second circuit to be electrically connected to the antenna, a processor (e.g., the processor 120 of FIG. 1, the second processor 530 of FIGS. 5A and 5B, the second processor 630 of FIG. 6) that is operatively connected to the switch, the first sensor, and the second sensor, and memory.

In one embodiment, the memory may include instructions that, when executed, cause the processor (e.g., the processor of FIGS. 2A and 2B) to control the switch so that one of the first circuit and the second circuit is electrically connected to the antenna on the basis of the identified first measurement value and the identified second measurement value in a first state in which at least a portion of the display is withdrawn from the housing using the driving unit.

An electronic device according to one embodiment may further include another processor (e.g., the first processor 520 of FIGS. 5A and 5B, the first processor 620 of FIG. 6) operatively connected to the processor (or the second processor), and the memory may further include instructions configured to cause the processor to: identify a drop state of the electronic device on the basis of a first measurement value of the first sensor in the first state in which at least a portion of the display is withdrawn from the housing; identify whether a grip of the electronic device is released on the basis of a second measurement value of the second sensor connected to the second circuit; determine finally the drop state of the electronic device when the grip of the electronic device is released; transmit a driving interrupt signal for controlling the driving unit to the other processor (or the first processor); and change the state to a second state in which at least a portion of the display is retracted into the interior of the electronic device by the other processor (or the first processor) controlling the driving unit on the basis of the driving interrupt signal transmitted from the processor (or the second processor).

The memory may further include instructions configured to cause the processor (or the second processor) to control the switch to connect the second sensor to the first circuit in the second state, and to determine grip information for controlling the specific absorption rate on the basis of a third measurement value identified from the second sensor connected to the first circuit.

In one embodiment, the memory may further include instructions for controlling the switch so that the processor (or the second processor) connects the second sensor to the second circuit on the basis of the electronic device being changed from the second state to the first state and the electronic device being recognized as being in a grip state on the basis of the third measurement value.

According to another embodiment, the memory may further include instructions for causing the processor (or the second processor) to temporarily transmit a signal connecting the second sensor to the second circuit on the basis of the electronic device changing from the second state to the first state and recognizing the electronic device grip state on the basis of the third measurement value, and then determine the electronic device grip release state for drop state monitoring on the basis of the second measurement value.

According to one embodiment, the first state may include one of a motor-driven state, a slide-out state, or a rollable area out state, and the second state may include one of a motor-reverse-driven state, a slide-in state, or a rollable area in state.

The electronic device may further include a main Printed Circuit Board (PCB) and a sub PCB, wherein the other processor (or first processor) is disposed on the main PCB, and the second sensor, the switch, and the processor (or second processor) are disposed on the sub PCB.

According to one embodiment, the processor (or the second processor) may be characterized in that it is included in some area within the other processor (or the first processor) or implemented as a separate configuration from the other processor (or the first processor).

According to one embodiment, the processor (or the second processor) may be characterized in that it transmits the driving interrupt signal to the other processor (or the first processor) through a wiring connected to a driving driver of a kernel layer within the processor.

According to one embodiment, the processor (or the second processor) may be configured to distinguish between a third measurement value identified from the second sensor connected to the first circuit and a second measurement value identified from the second sensor connected to the second circuit and store the same in memory or buffer.

The first circuit may be configured to recognize a grip state for controlling a specific absorption rate, and the second circuit may be configured to recognize a grip release state for monitoring a drop state.

According to one embodiment, the memory may further include instructions configured to, when executed, cause the processor (or the second processor) to recognize a drop state on the basis of the first measurement value transmitted from the first sensor when the electronic device changes from the second state to the first state and recognizes the electronic device as a grip state on the basis of a third measurement value obtained from the second sensor connected to the first circuit, and control the switch to connect the second sensor to the second circuit in response to a recognition event of the drop state.

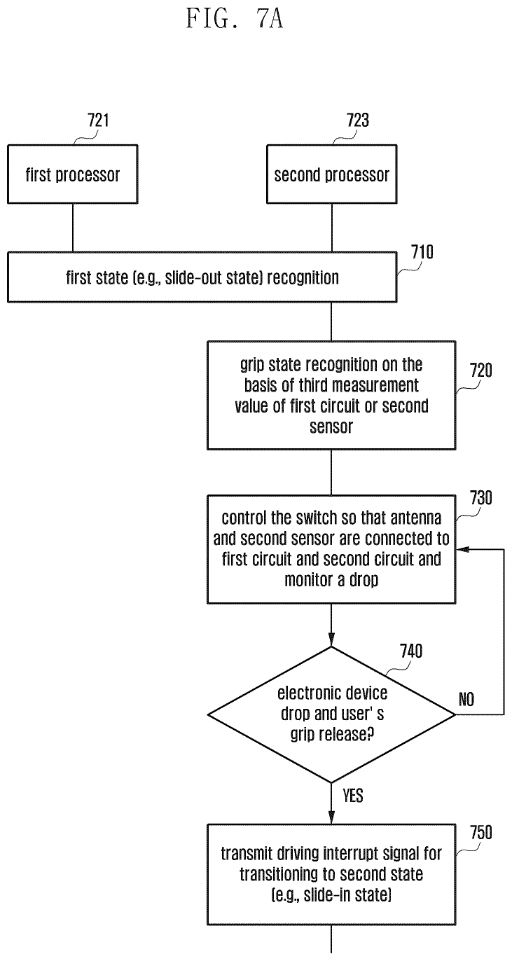

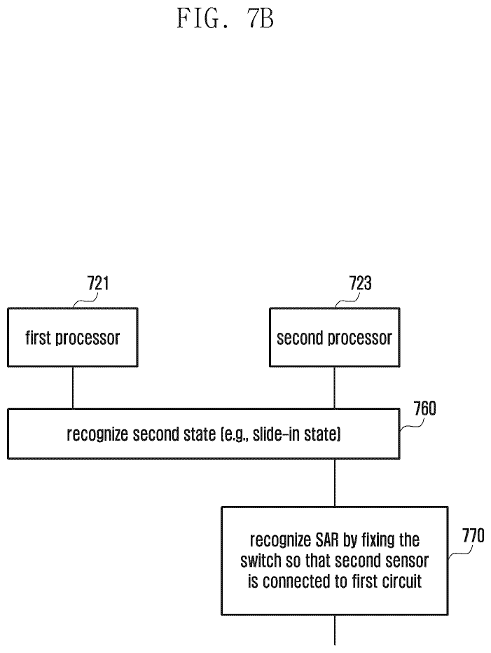

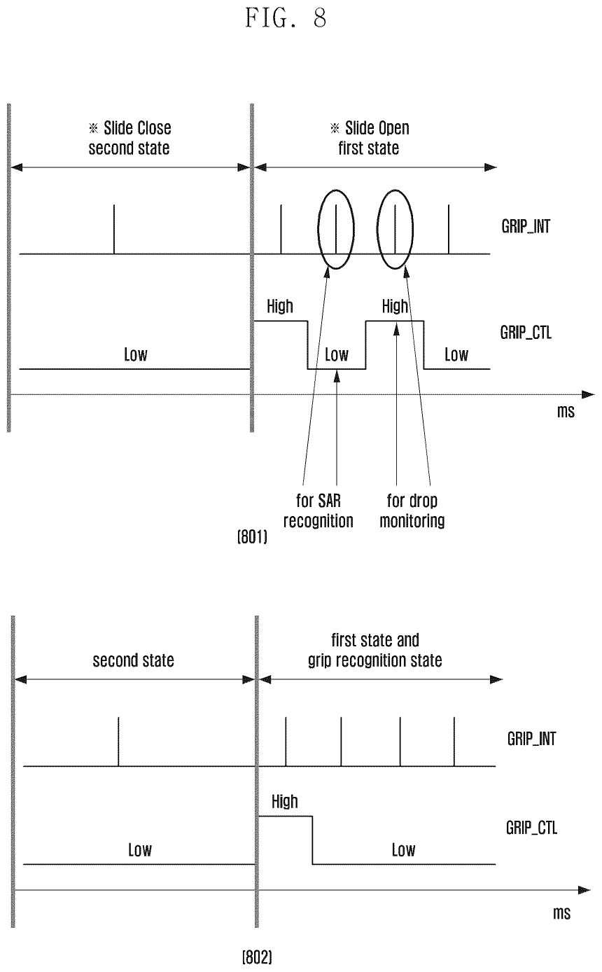

FIGS. 7A and 7B illustrate a method for monitoring a drop state of an electronic device including a sensor switch according to various embodiments of the disclosure, and FIG. 8 illustrates a mode operation timing of a sensor switch according to an embodiment of the disclosure.

Referring to FIGS. 7A and 7B, an electronic device 101 according to one embodiment may support a function of operating a grip sensor (e.g., the second sensor 550 of FIG. 5A, the second sensor 550 of FIG. 6) or/and a switch (e.g., the switch 560 of FIG. 5A, the switch 660 of FIG. 6) connected to the grip sensor in a first mode or a second mode.

The first mode may be a mode in which the grip sensor uses only the first electrical path (e.g., 5001 of FIG. 5A/6001 of FIG. 6) designed for grip recognition purposes for controlling the specific absorption rate, and the second mode (e.g., dual mode, switching mode, grip dual mode) may be a mode in which the grip sensor selectively uses the first electrical path and the second electrical path (e.g., 5002 of FIGS. 5A, 6002 of FIG. 6) designed for grip recognition purposes for monitoring the drop state.

According to one embodiment, the electronic device 101 may be predetermined to a first mode and be switched to a second mode when certain conditions (e.g., a first state of the electronic device 101 and an electronic device grip state) are satisfied.

FIG. 7A may be a control process related to a switch when the electronic device 101 is in a first state (e.g., a slide-out state), and FIG. 7B may be a control process related to a switch when the electronic device 101 is in a second state (e.g., a slide-in state).

Referring to FIG. 7A, in operation 710, a first processor 721 (e.g., a main processor) (e.g., the first processor 520 of FIGS. 5A and 5B, the first processor 620 of FIG. 6) and a second processor 723 (e.g., a low-power processor) (e.g., the second processor 530 of FIGS. 5A and 5B, the second processor 630 of FIG. 6)) may recognize a first state (e.g., a slide-out state) of the electronic device 101. The first state may include at least one of a slide-out state, a motor-driven state, a rollable-out state, an electronic device-opened state, and/or a camera lens-driven state.

For example, the electronic device 101 may recognize that at least a portion of the second housing 220 is moved outward (e.g., in the direction \textcircled{1}) from the first space 2101 in FIGS. 3A and 3B, thereby changing from a first state (e.g., a slide-in state) to a second state (e.g., a slide-out state).

In operation 720, the second processor 723 may recognize the grip state on the basis of a third measurement value transmitted from a second sensor (e.g., a grip sensor) connected to an antenna (e.g., the antenna 510 of FIG. 5A, the antenna 610 of FIG. 6)) through a first circuit (e.g., the first circuit 563 of FIG. 5A, the first circuit 663 of FIG. 6)) or a first path (e.g., the first path 5001 of FIG. 5A, the first path 6001 of FIG. 6).

In operation 730, the second processor 723 may control a switch to alternately connect an antenna and a second sensor (e.g., a grip sensor) to a first circuit or a second circuit (e.g., the second circuit 565 of FIG. 5A, the second circuit 665 of FIG. 6) (or a second path) on the basis of the electronic device 101 being recognized as being in the first state and the grip state, and may monitor the drop state.

According to one embodiment, in the second mode, the second processor 723 may control the switch by alternately transmitting a first level signal (e.g., a low level signal) or a second level signal (e.g., a high level signal) to the switch 560 at regular intervals, or may control the switch by temporarily transmitting a second level signal to the switch 560 for a certain period of time when a drop state is recognized while transmitting the first level signal.

For example, as illustrated in <801> of FIG. 8, the electronic device 101 may be controlled to operate in a first mode in which the second processor 723 transmits only a first level signal to the switch during a period in which the second state (e.g., a state in which at least a portion of the second housing 220 is coupled inward (e.g., direction \textcircled{2}) from the first space 2101 in FIGS. 3A and 3B), and it may be controlled to operate in a second mode in which the second processor 723 transmits a first level signal and a second level signal alternately to the switch at regular intervals during a period in which the electronic device 101 is recognized as the first state (or the first state and the grip state). The second processor 723 may determine grip recognition (e.g., at least one of a grip state, a grip release state, and a grip position) for controlling the SAR by a grip interrupt signal on the basis of a third measurement value transmitted from a grip sensor during the first level signal interval. The second processor 723 may determine whether the grip is released for drop state monitoring by a grip interrupt signal on the basis of a second measurement value transmitted from the grip sensor in the second level signal interval.

For another example, as illustrated in <802> of FIG. 8, the electronic device 101 may be operated in a first mode in which the second processor 723 transmits only a first level signal to the switch in the second state interval, and in response to the electronic device 101 being recognized as being in the first state and grip state, the electronic device 101 may temporarily transmit a second level signal to the switch for a certain period of time. The second processor 723 may determine whether the grip release state for drop state monitoring is in place on the basis of the second measurement value transmitted from the grip sensor in the second level signal interval.

In operation 740, the second processor 723 may recognize a drop state on the basis of a first measurement value transmitted from a first sensor (e.g., a motion sensor or a drop detection sensor (e.g., the first sensor 540 of FIG. 5A, the first sensor 640 of FIG. 6)) and determine whether the user has released the grip of the electronic device.

The second processor 723 may determine (or re-determine) whether the grip is released on the basis of the second measurement value transmitted from the second sensor (e.g., grip sensor) connected to the second circuit or the second path in the second level signal interval on the basis of the recognition of the drop state.

When the electronic device is recognized as being in a drop state and determined to be in a grip release state (YES), operation 750 may be performed. In operation 750, the second processor 723 may determine that the electronic device 101 is in a free drop or drop state on the basis of the second measurement value obtained in the second level signal interval, and transmit a driving interrupt signal to the first processor 721.

According to one embodiment, the first processor 721 may react to a driving interrupt signal to reversely rotate the driving unit (e.g., the driving unit 570 of FIG. 5A, the driving unit 670 of FIG. 6) to switch the electronic device 101 from a first state to a second state. The second state may include at least one of a slide-in state, a motor reverse-rotation state, a rollable-in state, an electronic device-closed state, and/or a camera lens-closed state. The electronic device 101 may prevent damage because of impact during a free drop by switching the electronic device 101 to the second state when the recognition of the drop state is not a malfunction, due to free drop monitoring.

For example, the second processor 723 may perform drop state monitoring by returning to operation 730 when the grip release state of the electronic device 101 is not established (or the grip state is maintained) on the basis of the second measurement value obtained in the second level signal interval.

Referring to FIG. 7B, in operation 760, the first processor 721 and the second processor 723 may recognize a second state (e.g., a slide-out state) of the electronic device 101.

In operation 770, the second processor may use the second sensor for grip recognition purposes for controlling the specific absorption rate by fixing the switch to the first mode so that the second sensor is connected to the first circuit.

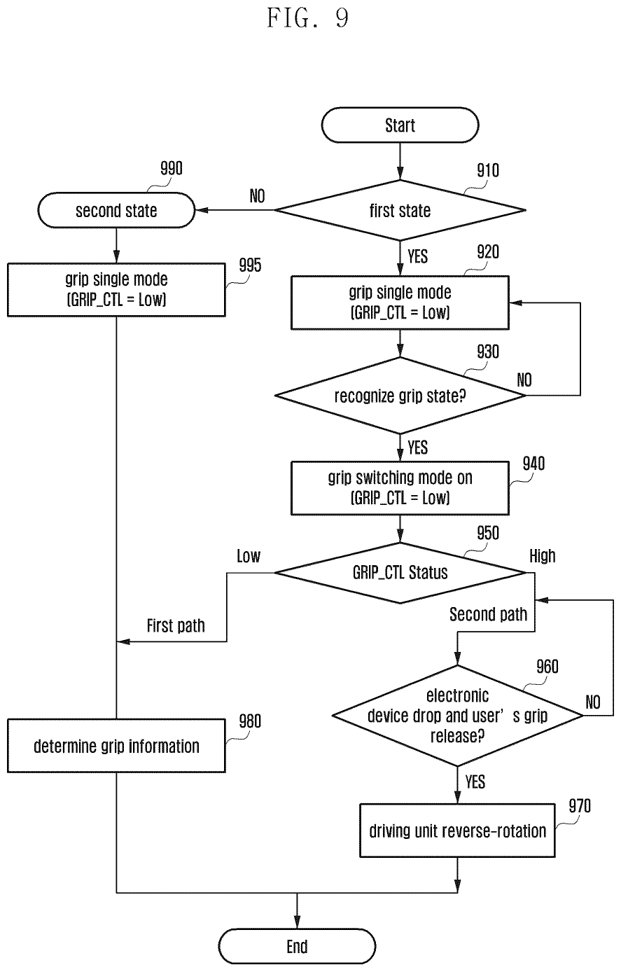

FIG. 9 illustrates a drop detection misrecognition method of an electronic device including a sensor switch according to an embodiment of the disclosure.

Referring to FIG. 9, an electronic device 101 according to one embodiment may determine, in operation 910, whether the electronic device 101 is recognized as being in a first state (e.g., a slide-out state, a motor rotation state, a display expansion state, a rollable-out state, an electronic device-open state) in which some components of the electronic device 101 are moved. In operation 920, when the electronic device 101 is recognized as being in the first state (e.g., YES in operation 910), the electronic device 101 may transmit a first level signal (e.g., a low level signal) to the switch (e.g., the switch 560 of FIG. 5A, the switch 660 of FIG. 6) and/or the grip sensor (e.g., the second sensor 550 of FIG. 5A, the second sensor 550 of FIG. 6) to operate (or maintain) in a grip single mode (e.g., a first mode).

According to one embodiment, the grip single mode (e.g., the first mode) may be a mode in which the grip sensor uses only a first path (e.g., the first path 5001 of FIG. 5A, the first path 6001 of FIG. 6) designed to recognize whether the electronic device is in a grip state to control the SAR, and the grip switching mode (e.g., the second mode) may be a mode in which the grip sensor alternately uses the first path and a second path (e.g., the second path 5002 of FIG. 5A, the second path 6002 of FIG. 6) designed to detect a grip release state for drop state monitoring.

In operation 930, the electronic device 101 may determine whether the grip state is recognized by a second sensor (e.g., a grip sensor) connected to the first circuit (e.g., the first circuit 563 of FIG. 5A, the first circuit 663 of FIG. 6) or a third measurement value transmitted from the first path. When the grip state of the electronic device 101 is not recognized by the third measurement value on the basis of the first path (e.g., NO in operation 930), the electronic device 101 may return to operation 920 and maintain the grip single mode.

In operation 940, when the electronic device 101 recognizes the grip state on the basis of the third measurement value (e.g., if YES in operation 930), the electronic device 101 may switch the switch and/or the grip sensor to the grip switching mode (e.g., turn the mode on). For example, in the grip switching mode, the electronic device 101 may alternately transmit a first level signal or a second level signal to the switch at regular intervals, and may distinguish and store in a buffer the third measurement value of the grip sensor transmitted through the first path in the first level signal interval and the second measurement value of the grip sensor transmitted through the second path in the second level signal interval.

In operation 950, the electronic device 101 may determine the control signal status of the switch (e.g., GRIP CTL status). When the control signal of the switch is a high level signal (or a second level signal), the electronic device 101 may proceed to operation 960, and when the control signal of the switch is a low level signal (or a first level signal), the electronic device 101 may proceed to operation 980. The first path may be used for the purpose of recognizing the grip status of the electronic device for the purpose of controlling the specific absorption rate by the grip sensor, and the second path may be used for the purpose of determining the grip release state for the purpose of monitoring the drop status.

In operation 960, when the control signal of the switch is a high level signal (or a second level signal), the electronic device 101 may determine whether the electronic device 101 is in a grip release state on the basis of a second measurement value transmitted through a second path for monitoring the drop state after the free drop or drop state of the electronic device is recognized on the basis of a first measurement value transmitted from a drop detection sensor or a motion sensor (e.g., the first sensor 540 of FIG. 5A, the first sensor 640 of FIG. 6).

In operation 970, the electronic device 101 may determine that the electronic device 101 is in a free drop or drop state on the basis of the second measurement value obtained in the second level signal interval, when the electronic device 101 is in a grip release state (e.g., YES in operation 970), and reversely rotate the driving unit (e.g., the driving unit 570 of FIG. 5A, the driving unit 670 of FIG. 6) to change the electronic device 101 from the first state to the second state (e.g., a slide-in state, a motor reverse-rotation state, a rollable-in state, an electronic device-closed state, or/and a camera lens-closed state). The electronic device 101 may monitor the drop state through the second path when the electronic device 101 is maintained in a grip state rather than a grip release state on the basis of the second measurement value (e.g., NO in operation 960).

In operation 980, the electronic device 101 may determine grip information (e.g., a grip state, a grip release state, a grip position, etc.) for the purpose of controlling specific absorption rate on the basis of the third measurement value when the control signal of the switch is a low level signal (or a first level signal).

In operation 990, the electronic device 101 may be recognized as a second state (e.g., a slide-in state, a motor reverse-rotation state, a rollable-in state, an electronic device-closed state, or/and a camera lens-closed state) in which some configuration of the electronic device 101 is not recognized as a first state (e.g., NO in operation 910).

In operation 995, the electronic device 101 may operate the switch and/or grip sensor in grip single mode on the basis of being recognized as the second state. In grip single mode, the electronic device 101 may determine grip information (e.g., a grip state, a grip release state, a grip position, etc.) for controlling the specific absorption rate on the basis of the third measurement value obtained from the grip sensor through the first path.

An electronic device 101 according to an embodiment may include an antenna, a display, a driving unit for moving at least a portion of the display, a first sensor that identifies a first measurement value for detecting motion information of the electronic device, a second sensor that identifies a second measurement value for detecting grip information of the electronic device, a first circuit and a second circuit selectively connecting the antenna and the second sensor, a switch for electrically connecting one of the first circuit and the second circuit to the antenna, and a low-power processor operatively connected to the switch, the first sensor, and the second sensor, wherein the low-power processor is configured to control, in a first state in which at least a portion of the display is withdrawn from the electronic device, a switch for selectively connecting one of the first circuit and the second circuit to the antenna and the second sensor on the basis of the first measurement value and the second measurement value, and to control the switch for connecting the first circuit and the second sensor in a second state in which at least a portion of the display is retracted into the interior of the electronic device.

An electronic device according to one embodiment may further include a main processor operatively connected to the low-power processor, wherein the low-power processor is configured to recognize a drop state of the electronic device on the basis of the first measurement value in the first state, determine whether the electronic device is in a grip release state for the purpose of monitoring the drop state on the basis of the second measurement value, and transmit a driving interrupt signal to the main processor for controlling the driving unit when the electronic device is in a grip release state on the basis of the second measurement value, and change the electronic device from the first state to the second state by the main processor controlling the driving unit on the basis of the driving interrupt signal transmitted from the low-power processor.

The low-power processor may be configured to transmit the driving interrupt signal to the main processor through wiring connected to a driving driver included in a kernel layer within the main processor.

In one embodiment, the low-power processor may be configured to alternately transmit to the switch a first level signal connecting the second sensor to the first circuit and a second level signal connecting the second sensor to the second circuit on the basis of the electronic device being in the first state and the electronic device being recognized as being in a grip state on the basis of the first measurement value.

According to an embodiment, the low-power processor may be configured to determine at least one of an electronic device grip state, a grip position, and a grip release state for controlling a specific absorption rate on the basis of sensing information transmitted from a second sensor connected to the first circuit, and to determine an electronic device grip release state for monitoring a drop state on the basis of sensing information transmitted from a second sensor connected to the second circuit.

According to one embodiment, the low-power processor may be characterized by being included in some area of the main processor or implemented as a separate hardware configuration from the main processor.

According to one embodiment, the first circuit may be designed to recognize grip information for controlling specific absorption rate, and the second circuit may be designed to detect grip information for monitoring a drop state.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore®), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore®), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
an antenna;
a display;
a driving unit that moves at least a portion of the display;
a first sensor that identifies a first measurement value for detecting motion information of the electronic device;
a second sensor that identifies a second measurement value for detecting grip information of the electronic device;
a first circuit and a second circuit that are selectively connectable to the second sensor;
a switch by which one of the first circuit or the second circuit is electrically connected to the antenna;
memory, comprising one or more storage media, storing instructions; and
at least one processor communicatively coupled to the switch, the first sensor, the second sensor, and the memory;
wherein the instructions, when executed by the at least one processor individually or collectively, cause the electronic device to:
control the switch so that one of the first circuit and the second circuit is electrically connected to the antenna based on the identified first measurement value and the identified second measurement value in a first state in which at least a portion of the display is withdrawn from the housing using the driving unit.

2. The electronic device of claim 1, further comprising:
another processor operatively connected to the at least one processor,
wherein the instructions, when executed by the at least one processor individually or collectively, further cause the electronic device to:
identify a drop state of the electronic device based on a first measurement value of the first sensor in the first state in which at least a portion of the display is withdrawn from the housing,
identify whether a grip of the electronic device is released based on a second measurement value of the second sensor connected to the second circuit,
determine finally the drop state of the electronic device when the grip of the electronic device is released,
transmit a driving interrupt signal for controlling the driving unit to the other processor, and
change the state to a second state in which at least a portion of the display is retracted into an interior of the electronic device by the other processor controlling the driving unit in response to the driving interrupt signal.

3. The electronic device of claim 2, wherein the instructions, when executed by the at least one processor individually or collectively, further cause the electronic device to:
control the switch to connect the second sensor to the first circuit in the second state, and
determine grip information for controlling a specific absorption rate based on a third measurement value identified from the second sensor connected to the first circuit.

4. The electronic device of claim 3, wherein the instructions, when executed by the at least one processor individually or collectively, further cause the electronic device to:
control the switch to connect the second sensor to the second circuit based on the electronic device changing from the second state, in which at least a portion of the display is withdrawn to the outside, to the first state and being recognized as an electronic device grip state based on a third measurement value.

5. The electronic device of claim 3, wherein the instructions, when executed by the at least one processor individually or collectively, further cause the electronic device to:
temporarily transmit a signal for connecting the second sensor to the second circuit based on the electronic device changing from the second state, in which at least a portion of the display is withdrawn to the outside, to the first state and being recognized as an electronic device grip state based on a third measurement value, and then determine the electronic device grip release state for drop state monitoring based on the second measurement value.

6. The electronic device of claim 4,
wherein the first state comprises one of a motor-driven state, a slide-out state, or a rollable area out state, and
wherein the second state comprises one of a motor-reverse-driven state, a slide-in state, or a rollable area in state.

7. The electronic device of claim 6, further comprising:
a main Printed Circuit Board (PCB) and a sub PCB,
wherein the other processor is disposed on the main PCB, and
wherein the second sensor, the switch, and the at least one processor are disposed on the sub PCB.

8. The electronic device of claim 7, wherein the at least one processor is included in some area within the other processor or implemented as a separate configuration from the other processor.

9. The electronic device of claim 7, wherein the instructions, when executed by the at least one processor individually or collectively, further cause the electronic device to:
transmit the driving interrupt signal from the processor to the other processor through a wiring connected to a driving driver of a kernel layer within the processor.

10. The electronic device of claim 7, wherein the instructions, when executed by the at least one processor individually or collectively, further cause the electronic device to:
distinguish between a third measurement value identified from the second sensor connected to the first circuit and a second measurement value identified from the second sensor connected to the second circuit and store the same in the memory or buffer.

11. The electronic device of claim 10,
wherein the first circuit is configured to recognize a grip state for controlling a specific absorption rate, and
wherein the second circuit is configured to recognize a grip release state for monitoring a drop state.

12. The electronic device of claim 1, wherein the instructions, when executed by the at least one processor individually or collectively, further cause the electronic device to:
recognize a drop state based on the first measurement value transmitted from the first sensor when the electronic device changes from a second state, in which at least a portion of the display is withdrawn to the outside, to the first state and recognizes the electronic device as a grip state based on a third measurement value obtained from the second sensor connected to the first circuit; and
control the switch to connect the second sensor to the second circuit in response to a recognition event of the drop state.

13. The electronic device of claim 1, wherein the at least one processor comprises a low-power processor.

14. The electronic device of claim 13, wherein the instructions, when executed by the at least one processor individually or collectively, further cause the low-power processor of the electronic device to:
alternately transmit to the switch a first level signal connecting the second sensor to the first circuit and a second level signal connecting the second sensor to the second circuit based on the electronic device being in the first state and the electronic device being recognized as being in a grip state based on the first measurement value.

15. The electronic device of claim 13, wherein the instructions, when executed by the at least one processor individually or collectively, further cause the low-power processor of the electronic device to:
determine at least one of an electronic device grip state, a grip position, and a grip release state for controlling a specific absorption rate based on sensing information transmitted from a second sensor connected to the first circuit; and
determine an electronic device grip release state for monitoring a drop state based on sensing information transmitted from a second sensor connected to the second circuit.

16. One or more non-transitory computer-readable storage media storing one or more computer programs including computer-executable instructions that, when executed by one or more processors of an electronic device individually or collectively, cause the electronic device to perform operations, the operations comprising:
controlling a switch so that one of a first circuit and a second circuit is electrically connected to an antenna based on an identified first measurement value and an identified second measurement value in a first state in which at least a portion of a display is withdrawn from a housing using a driving unit.

17. The one or more non-transitory computer-readable storage media of claim 16, the operations further comprising:
identifying a drop state of the electronic device based on a first measurement value of a first sensor in the first state in which at least a portion of the display is withdrawn from the housing,
identifying whether a grip of the electronic device is released based on a second measurement value of a second sensor connected to the second circuit,
determining finally the drop state of the electronic device when the grip of the electronic device is released,
transmitting a driving interrupt signal for controlling the driving unit to another processor, and
changing the state to a second state in which at least a portion of the display is retracted into an interior of the electronic device by the other processor controlling the driving unit in response to the driving interrupt signal.
